(19) United States
(12) Patent Application Publication
(10) Pub. No.: US 2015/0103744 A1
(43) Pub. Date: Apr. 16, 2015

(54) MODE SWITCHING METHOD AND APPARATUS

(71) Applicant: Huawei Technologies Co., Ltd., Shenzhen (CN)

(72) Inventors: Xibo SUN, Shanghai (CN); Wen HU, Shanghai (CN)

(21) Appl. No.: 14/495,415

(22) Filed: Sep. 24, 2014

(30) Foreign Application Priority Data
Sep. 25, 2013 (CN) 201310441834.1

(51) Int. Cl. H04W 88/06; H04W 60/04

(52) U.S. Cl. CPC H04W 88/06; H04W 60/04
USPC 370/328

(57) ABSTRACT

Embodiments of the present invention provide a mode switching method and apparatus, which relate to the communications field and are used to improve user experience. The method includes: when a user equipment UE is in a state of accessing a first network in a first network mode of a first communications mode, determining, by the UE, whether the first network supports a first subsystem; enabling, by the UE, if the UE determines that the first network does not support the first subsystem and when the UE does not access a second network in the first communications mode, a second communications mode and accessing the second network in the second communications mode; and sending, by the UE, a first registration request message to the second network. The embodiments of the present invention are applicable to a service transmission scenario.

### CROSS-REFERENCE TO RELATED APPLICATION

This application claims priority to Chinese Patent Application No. 201310441834.1, filed on Sep. 25, 2013, which is hereby incorporated by reference in its entirety.

### TECHNICAL FIELD

The present invention relates to the communications field, and in particular, to a mode switching method and apparatus.

### BACKGROUND

VoLTE (Voice over Long Term Evolution, voice over long term evolution) is an IMS (Internet Protocol Multimedia Subsystem, Internet Protocol multimedia subsystem)-based voice service defined in 3GPP (3rd Generation Partnership Project, 3rd Generation Partnership Project) specifications. On an LTE (Long Term Evolution, Long Term Evolution) network, voice data of the VoLTE may be transmitted as IP (Internet Protocol, Internet Protocol) data. Compared with voice services on a 2G (2nd Generation Mobile Communications System, 2nd generation mobile communications system) network and a 3G (3rd Generation Mobile Communications System, 3rd generation mobile communications system) network, the VoLTE substantially shortens call connection duration by introducing technologies such as high definition codec, thereby providing better service experience for users.

Single-card dual-standby means that only one SIM (Subscriber Identity Module, subscriber identity module) card is inserted into a terminal, where the terminal can be in standby mode separately in terms of a CS (Circuit Switched, circuit switched) domain service and a PS (Packet Switched, packet switched) domain service and can camp on two different networks.

For an existing terminal supporting the IMS and of which a prior voice domain is IMS PS domain only, if an LTE network on which the terminal is located does not support the IMS, it is necessary to disable the LTE and switch to another network mode.

In a process of implementing the switching of the foregoing network mode, the inventor finds that the prior art has at least the following problems: After the terminal switches to another network mode, a data service is transmitted in the another network mode. Because a transmission rate of a data service in the another network mode is lower than a transmission rate of a data service of LTE, a transmission rate of a subsequent data service decreases after the terminal switches a network mode, thereby degrading user experience.

### SUMMARY

Embodiments of the present invention provide a quick mode switching method and apparatus, which are used to ensure a transmission rate of a data service when a terminal switches to another network mode, thereby improving user experience.

To achieve the foregoing objectives, the following technical solutions are adopted in the embodiments of the present invention:

According to a first aspect, an embodiment of the present invention provides a mode switching method, including: determining, by a UE, when the user equipment UE is in a state of accessing a first network in a first network mode of a first communications mode, whether the first network supports a first subsystem, where the first network mode of the first communications mode is used for supporting access of the UE to the first network, and the first network provides a first service for the UE by using the first subsystem; enabling, by the UE, if the UE determines that the first network does not support the first subsystem and when the UE does not access a second network in the first communications mode, a second communications mode and accessing the second network in the second communications mode, where in addition to the first network, the second network supports establishment of a first attachment, and the first attachment is used for providing the first service for the UE over the second network; and sending, by the UE, a first registration request message to the second network, where the first registration request message carries first identification information, so that the second network establishes the first attachment according to the first identification information.

In a first possible implementation manner of the first aspect, the enabling, by the UE, if the UE determines that the first network does not support the first subsystem and when the UE does not access a second network in the first communications mode, a second communications mode and accessing the second network in the second communications mode includes: when the first communications mode provides a second network mode, disabling, by the UE, the second network mode of the first communications mode, where the second network mode of the first communications mode is used for supporting access of the UE to the second network; and enabling, by the UE, the second communications mode and accessing the second network in the second communications mode.

With reference to the first aspect, in a second possible implementation manner of the first aspect, the enabling, by the UE, if the UE determines that the first network does not support the first subsystem and when the UE does not access a second network in the first communications mode, a second communications mode and accessing the second network in the second communications mode includes: when the first communications mode does not support a second network mode, enabling, by the UE, the second communications mode and accessing the second network in the second communications mode.

With reference to the first aspect or any one of the first to the second possible implementation manners of the first aspect, in a third possible implementation manner of the first aspect, before the determining, by the UE, when the user equipment UE is in the first network mode of the first communications mode, whether the first network supports the first subsystem, the method further includes: enabling, by the UE, the first network mode of the first communications mode and accessing the first network in the first network mode of the first communications mode.

With reference to the first aspect or any one of the first to the third possible implementation manners of the first aspect, in a fourth possible implementation manner of the first aspect, the method further includes: when the UE is in a state of accessing the first network in the first network mode of the first communications mode and accessing the second network in the second communications mode, determining, by the UE, whether the first network supports the first subsystem; and if the UE determines that the first network supports the first subsystem, sending, by the UE, a first deletion request message to the second network and disabling the second communications mode, where the first deletion request message is used by the UE to instruct the second network to delete the first attachment.

With reference to the first aspect or any one of the first to the fourth possible implementation manners of the first aspect, in a fifth possible implementation manner of the first aspect, the determining, by the UE, whether the first network supports a first subsystem includes: receiving, by the UE, a first message sent by the first network, where the first message carries identification information about whether the first network supports the first subsystem; and determining, by the UE according to the identification information carried in the first message, whether the first network supports the first subsystem.

With reference to the first aspect or any one of the first to the fifth possible implementation manners of the first aspect, in a sixth possible implementation manner of the first aspect, the first network mode includes a Long Term Evolution LTE network mode; the first network includes an LTE network; the first subsystem includes an Internet Protocol multimedia subsystem IMS; the first service includes a voice service; the determining, by the UE, when the user equipment UE is in the first network mode of the first communications mode, whether the first network supports the first subsystem includes: when the user equipment UE is in the LTE network mode of the first communications mode, determining, by the UE, whether the LTE network supports the IMS, where the first attachment includes a CS domain attachment; the first registration request message includes a CS domain registration request message; and the sending, by the UE, a first registration request message to the second network includes: sending, by the UE, the CS domain registration request message to the second network.

With reference to the sixth possible implementation manner of the first aspect, in a seventh possible implementation manner of the first aspect, the second network includes: a Global System for Mobile Communications GSM network, a Time Division-Synchronization Code Division Multiple Access TD-SCDMA network, or a Wideband Code Division Multiple Access WCDMA network.

With reference to the seventh possible implementation manner of the first aspect, in an eighth possible implementation manner of the first aspect, when the first communications mode provides the second network mode, the second network mode includes: a GSM network mode, a TD-SCDMA network mode, or a WCDMA network mode.

According to a second aspect, an embodiment of the present invention provides a user equipment UE, including: a determining unit, configured to, when the UE is in a first network mode of a first communications mode, determine whether a first network supports a first subsystem, where the first network mode of the first communications mode is used for supporting access of the UE to the first network, and the first network provides a first service for the UE by using the first subsystem; a control unit, configured to, when the determining unit determines that the first network does not support the first subsystem and the UE does not access the second network in the first communications mode, enable a second communications mode and access the second network in the second communications mode, where in addition to the first network, the second network supports establishment of the first attachment; and a sending unit, configured to send a first registration request message to the second network, where the first registration request message carries first identification information, so that the second network establishes the first attachment according to the first identification information.

In a first possible implementation manner of the second aspect, the control unit is specifically configured to, when the determining unit determines that the first network does not support the first subsystem and the first communications mode provides the second network mode, disable the second network mode of the first communications mode, enable the second communications mode, and access the second network in the second communications mode, where the second network mode of the first communications mode is used for supporting access of the UE to the second network.

With reference to the second aspect, in a second possible implementation manner of the second aspect, the control unit is specifically configured to, when the first communications mode does not provide a second network mode, enable the second communications mode and access the second network in the second communications mode.

With reference to the second aspect or any one of the first to the second possible implementation manners of the second aspect, in a third possible implementation manner of the second aspect, the control unit is further configured to enable the first network mode of the first communications mode and access the first network in the first network mode of the first communications mode.

With reference to the second aspect or any one of the first to the third possible implementation manners of the second aspect, in a fourth possible implementation manner of the second aspect, the determining unit is further configured to, when the UE is in a state of accessing the first network in the first network mode of the first communications mode and accessing the second network in the second communications mode, determine whether the first network supports the first subsystem; the sending unit is further configured to send a first deletion request message to the second network when the determining unit determines that the first network supports the first subsystem, where the first deletion request message is used by the UE to instruct the second network to delete the first attachment; and the control unit is further configured to disable the second communications mode after the sending unit sends the first deletion request message to the second network.

With reference to the second aspect or any one of the first to the fourth possible implementation manners of the second aspect, in a fifth possible implementation manner of the second aspect, the UE further includes: a receiving unit, configured to receive a first message sent by the first network, where the first message carries identification information about whether the first network supports the first subsystem, and the determining unit is specifically configured to, according to the identification information carried in the first message received by the receiving unit, determine whether the first network supports the first subsystem.

With reference to the second aspect or any one of the first to the fifth possible implementation manners of the second aspect, in a sixth possible implementation manner of the second aspect, the first network mode includes a Long Term Evolution LTE network mode; the first network includes an LTE network; the first subsystem includes an Internet Protocol multimedia subsystem IMS; the first service includes a voice service; the determining unit is specifically configured to, when the UE is in the LTE network mode of the first communications mode, determine whether the LTE network supports the IMS; the first attachment includes a CS domain attachment; the first registration request message includes a CS domain registration request message; and the sending unit is specifically configured to send the CS domain registration request message to the second network.

With reference to the sixth possible implementation manner of the second aspect, in a seventh possible implementation manner of the second aspect, the second network includes: a Global System for Mobile Communications GSM network, a Time Division-Synchronization Code Division Multiple Access TD-SCDMA network, or a Wideband Code Division Multiple Access WCDMA network.

With reference to the seventh possible implementation manner of the second aspect, in an eighth possible implementation manner of the second aspect, when the first communications mode provides the second network mode, the second network mode includes: a GSM network mode, a TD-SCDMA network mode, or a WCDMA network mode.

According to the mode switching method and apparatus provided in the embodiments of the present invention, when a UE is in a first network mode of a first communications mode and a first network does not support a first subsystem, and when the UE does not access a second network in the first communications mode, the UE enables a second communications mode, accesses the second network in the second communications mode, and establishes an attachment corresponding to a first service on the second network. In this way, when the first network cannot provide the first service, the UE can still access the first network in the first network mode of the first communications mode; in addition, the UE accesses the second network in the second network mode, so that the first service can be transferred to the second network for transmission; and another service except the first service can still be transmitted by using the first network, thereby ensuring a transmission rate of the another service after the UE switches a network mode, and improving user experience.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and persons of ordinary skill in the art may still derive other drawings from these accompanying drawings without creative efforts.

FIG. 1 is a schematic flowchart of a mode switching method according to an embodiment of the present invention;

FIG. 2 is a schematic flowchart of another mode switching method according to an embodiment of the present invention;

FIG. 3 is a schematic flowchart of another mode switching method according to an embodiment of the present invention;

FIG. 4 is a schematic functional diagram of a user equipment according to an embodiment of the present invention;

FIG. 5 is a schematic functional diagram of another user equipment according to an embodiment of the present invention; and

FIG. 6 is a schematic structural diagram of a user equipment according to an embodiment of the present invention.

### DESCRIPTION OF EMBODIMENTS

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by persons of ordinary skill in the art based on the embodiments of the present invention without creative efforts shall fall within the protection scope of the present invention.

An embodiment of the present invention provides a mode switching method. As shown in FIG. 1, the method includes:

101. When a UE (User Equipment, user equipment) is in a state of accessing a first network in a first network mode of a first communications mode, the UE determines whether the first network supports a first subsystem.

The first network mode of the first communications mode is used for supporting access of the UE to the first network. The first network provides a first service for the UE by using the first subsystem.

It should be noted that the UE has a single-card dual-standby capability. In other words, the UE has a capability of simultaneously working in two communications modes, that is, the first communications mode and a second communications mode. The UE may separately support different networks in the two communications modes. The UE may separately transmit different types of services over the different networks that the UE accesses in the two communications modes. Certainly, the UE may also access only one network in one of the two communications modes.

It should be noted that the first network may support the first subsystem, or may not support the first subsystem.

It should be noted that when the first network supports the first subsystem, the first network provides the first service only by using the first subsystem.

Specifically, the UE may receive a first message sent by the first network. The UE determines, according to identification information carried in the first message, whether the first network supports the first subsystem.

The first message carries the identification information identifying whether the first network supports the first subsystem.

In other words, when accessing the first network in the first network mode of the first communications mode, the UE receives the first message that is sent by the first network and carries the identification information identifying whether the first network supports the first subsystem. After receiving the first message, the UE determines, according to the identification information carried in the first message, whether the first network supports the first subsystem.

Further, the first network mode includes an LTE (Long Term Evolution, Long Term Evolution) network mode. The first network includes an LTE network. The first subsystem includes an IMS (Internet Protocol Multimedia Subsystem, Internet Protocol multimedia subsystem). The first service includes a voice service.

In this case, that when a UE (User Equipment, user equipment) is in a state of accessing a first network in a first network mode of a first communications mode, the UE determines whether the first network supports a first subsystem includes: when the UE is in the LTE network mode of the first communications mode, the UE determines whether the LTE network supports the IMS.

Further, when the UE updates a tracking area, an updated LTE network sends a message related to the LTE network to the UE. The message carries information about whether the LTE network supports the IMS. After receiving the message, the UE determines, according to the information carried in the message, whether the LTE network supports the IMS.

It should be noted that the LTE network may support the IMS, or may not support the IMS. When the UE needs to transmit voice over LTE (Voice Over LTE, VoLTE for short), the UE needs to determine whether an LTE network that the UE currently accesses supports the IMS because the voice over LTE must be transmitted based on the IMS over the LTE network.

It should be noted that the LTE network in this embodiment of the present invention can provide the voice service only by using the IMS. In this case, the voice service is the voice over LTE and is transmitted as data in a PS (Packet Switched, packet switched) domain.

It should be noted that a PS domain of the UE is registered with the LTE network no matter whether the LTE network supports the IMS or not. When the LTE network supports the IMS, voice data of the UE is transmitted in the PS domain by using the IMS; and a data service of the UE is also transmitted in the PS domain. When the LTE network does not support the IMS, the LTE network does not provide the voice service, but the data service of the UE can still be transmitted in the PS domain that is registered with the LTE network.

It should be noted that the first communications mode may further includes another network mode; and in this case, the UE may further access another network in the another network mode of the first communications mode, which is not limited in the present invention.

102. If the UE determines that the first network does not support the first subsystem and when the UE does not access a second network in the first communications mode, the UE enables the second communications mode and accesses the second network in the second communications mode.

In addition to the first network, the second network supports establishment of a first attachment. The first attachment is used for providing the first service for the UE over the second network.

Specifically, at a present moment, the first network does not support the first subsystem. Therefore, the first network cannot provide transmission of data related to the first service for the UE. That is, the UE cannot acquire the data related to the first service by using the first network. In this case, because the UE has the single-card dual-standby capability, if the UE does not access the second network in the first communications mode, the UE can enable the second communications mode and access, in the second communications mode, the second network that supports the establishment of the first attachment, so as to acquire the data related to the first service by using the second network.

It should be noted that the UE can access a certain network in only one communications mode. When the UE can separately access a certain network in both communications modes, the UE needs to disable a function of accessing the network in one of the two communications modes. Therefore, when the UE can access the second network in the first communications mode, the UE cannot simultaneously access the second network in the second communications mode. In other words, before the UE accesses the second network in the second communications mode, it must be determined that the UE does not access the second network in the first communications mode.

It should be noted that a process of enabling the second communications mode by the UE is a process of switching from a single-card single-standby mode to a single-card dual-standby mode by the UE.

It should be noted that if the UE is in the first network mode of the first communications mode and determines that the first network supports the first subsystem, in this case, the UE does not need to make any change because the UE has transmitted the data related to the first service by using the first subsystem.

Further, the first attachment includes a CS domain attachment.

Further, when the first network mode is the LTE network mode, in this case, the LTE network can provide the voice service only by using the IMS. If the UE determines that the LTE network does not support the IMS, the UE cannot transmit data related to the voice over LTE by using the LTE network.

It should be noted that after the UE determines that the LTE network does not support the IMS, although the UE cannot transmit the data related to the voice over LTE by using the LTE network, the UE can transmit data related to another service by using the LTE network. For example, the data service can still be transmitted in the PS domain by using the LTE network.

Further, when the UE does not access the second network in the first communications mode, that the UE enables the second communications mode and accesses the second network in the second communications mode may be classified into two cases.

In the first case, when the first communications mode provides the second network mode, the UE disables the second network mode of the first communications mode. The UE enables the second communications mode and accesses the second network in the second communications mode.

The second network mode of the first communications mode is used for supporting access of the UE to the second network.

It should be noted that the UE does not access the second network in the first communications mode means that the UE does not access the second network in the second network mode of the first communications mode.

In other words, the UE can access the second network in the second network mode of the first communications mode. In this case, to access the second network in the second communications mode, the UE needs to disable a function of accessing the second network in the second network mode of the first communications mode. That is, the UE disables the second network mode of the first communications mode, so as to ensure that the UE cannot access the second network in the first communications mode. After disabling the second network mode of the first communications mode, the UE can access the second network in the second communications mode.

Further, the disabling, by the UE, the second network mode of the first communications mode may be specifically as follows: The UE removes a frequency range corresponding to the second network mode from a frequency range searched by the UE in the first communications mode.

It should be noted that the UE may access different types of networks in the second network mode of the first communications mode. When the UE disables the second network mode of the first communications mode, a type of the second network that the UE accesses in the second communications mode may be the same as a type of a network that the UE accesses in the second network mode of the first communications mode.

For example, a network that the UE may access in the second network mode of the first communications mode is a TD-SCDMA (Time Division-Synchronous Code Division Multiple Access, Time Division-Synchronous Code Division Multiple Access) network or a GSM (Global System for Mobile Communications, Global System for Mobile Communications) network. After the UE disables the second network mode of the first communications mode, the second network that the UE accesses in the second communications mode may be a TD-SCDMA network or a GSM network.

In the second case, when the first communications mode does not provide the second network mode, the UE enables the second communications mode and accesses the second network in the second communications mode.

In other words, the UE cannot access the second network in the first communications mode. That is, the second network is not included in networks that the UE can access in the first communications mode. In this case, the UE may directly enable the second communications mode and access the second network in the second communications mode.

It should be noted that the UE may also disable one network mode of the first communications mode, then enable the second communications mode, and access the second network in the second communications mode, which is not limited in the present invention.

For example, the networks that the UE can access in the first communications mode include the LTE network, the TD-SCDMA network, and the GSM network. If the second network is a WCDMA (Wideband Code Division Multiple Access, Wideband Code Division Multiple Access) network, the UE may directly enable the second communications mode and access the WCDMA network in the second communications mode.

Certainly, the UE may disable one network mode of the first communications mode. For example, the UE disables a GSM network mode of the first communications mode to increase a type of a network that the UE accesses in the second communications mode.

Further, the second network includes: the GSM network, the TD-SCDMA network, or the WCDMA network.

Further, when the first communications mode provides the second network mode, the second network mode includes: the GSM network mode, the TD-SCDMA network mode, or the WCDMA network mode.

103. The UE sends a first registration request message to the second network.

The first registration request message carries first identification information, so that the second network establishes the first attachment according to the first identification information.

It should be noted that the UE transfers the first service to the second communications mode; however, another service except the first service is still transmitted by using the first network in the first communications mode.

Specifically, after accessing the second network, the UE needs to instruct the second network to establish a transmission link used for transmitting the data related to the first service. In this case, the UE sends the first registration request message to the second network.

Further, the first registration request message includes a CS domain registration request message.

That the UE sends the first registration request message to the second network includes that: the UE sends the CS domain registration request message to the second network.

Exemplarily, when the UE needs to transmit the voice service by using the LTE network, the LTE network cannot transmit the voice service because the LTE network does not support the IMS. If the second network is the GSM network and the UE can access the GSM network in the second communications mode, in this case, the UE can access the GSM network in the second communication mode when the UE cannot access the GSM network in the first communications mode. After the UE accesses the GSM network, the UE sends the CS domain registration request message that carries the first identification information to the GSM network. The GSM network may establish, according to the received CS domain registration request message, a CS domain attachment corresponding to the voice service, so that the GSM network can provide the voice service for the UE. In this case, the UE may further transmit, by using the LTE network, another data service transmitted in the PS domain.

According to the mode switching method provided in this embodiment of the present invention, when the user equipment UE is in a first network mode of a first communications mode and a first network does not support the first subsystem, in a case in which the UE does not access a second network in the first communications mode, the UE enables the second communications mode, accesses the second network in the second communications mode, and establishes a first attachment on the second network. In this way, when the first network cannot provide the first service, the UE can still access the first network in the first network mode of the first communications mode; in addition, the UE accesses the second network in the second network mode, so that the first service can be transferred to the second network for transmission; and another service except the first service can still be transmitted by using the first network, thereby ensuring a transmission rate of the another service after the UE switches a network mode, and improving user experience.

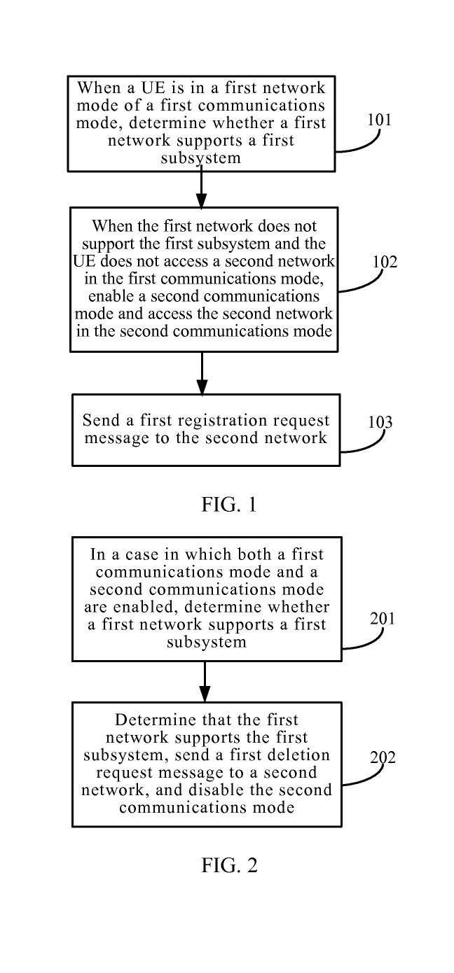

An embodiment of the present invention provides a mode switching method. As shown in FIG. 2, the method includes:

201. When a UE is in a state of accessing a first network in a first network mode of a first communications mode and accessing a second network in a second communications mode, the UE determines whether the first network supports the first subsystem.

It should be noted that, in this embodiment of the present invention, the first service is transmitted over the second network; and another service except the first service is transmitted over the first network.

It should be noted that the first network may support the first subsystem, or may not support the first subsystem.

It should be noted that when the first network supports the first subsystem, the first network provides the first service only by using the first subsystem.

It should be noted that, with comparison between the first service provided by the first network for the UE by using the first subsystem and the first service provided by the second network for the UE, the first service provided by the first network for the UE by using the first subsystem is superior to the first service provided by the second network for the UE in quality. Therefore, the UE needs to detect whether the first network can provide the first service for the UE, so that when it is detected that the first network supports the first subsystem, the first service can be timely switched to the first network that can provide better quality.

Specifically, the UE may receive a first message sent by the first network. The first message carries identification information identifying whether the first network supports the first subsystem. The UE determines, according to the identification information carried in the first message, whether the first network supports the first subsystem.

In other words, when accessing the first network in the first network mode of the first communications mode, the UE receives the first message that is sent by the first network and carries the identification information identifying whether the first network supports the first subsystem. After receiving the identification information, the UE determines, according to the identification information, whether the first network supports the first subsystem.

Exemplarily, it is assumed that the first network is an LTE network, the second network is a GSM network, the first subsystem is an IMS, and the first service is a voice service. In this case, the UE accesses the LTE network in the first network mode of the first communications mode and simultaneously accesses the GSM network in the second communications mode. That is, a PS domain of the UE is registered with the LTE network to provide a data service; and a CS domain of the UE is registered with the GSM network to provide the voice service.

Further, when the UE updates a tracking area, an updated LTE network sends a message to the UE. The message carries information about whether the LTE network supports the IMS. After receiving the message, the UE determines, according to the information carried in the message, whether the LTE network supports the IMS.

202. If the UE determines that the first network supports the first subsystem, the UE sends a first deletion request message to the second network and disables the second communications mode.

The first deletion request message is used for instructing the second network to delete a first attachment of the UE on the second network.

Specifically, when the UE determines that the first network supports the first subsystem, the first network may provide the first service for the UE by using the first subsystem. Because the first service provided by the first network for the UE by using the first subsystem is superior to the first service provided by the second network for the UE in quality, in this case, the UE can switch the first service to the first network, so that data related to the first service of the UE is transmitted over the first network by using the first subsystem. In addition, the UE needs to trigger a deletion of an attachment corresponding to the first service on the second network, where the deletion is performed by the second network. In this case, the UE may send the first deletion request message that instructs the second network to delete the first attachment to the second network. The UE disables the second communications mode, so as to switch to a case in which the UE accesses the first network only in the first network mode of the first communications mode.

It should be noted that a process of sending the first deletion request message to the second network and disabling the second communications mode by the UE is a process of switching from a single-card dual-standby mode to a single-card single-standby mode by the UE.

Further, in a case in which the UE determines that the LTE network supports the IMS and disables the second communications mode, the UE sends the first deletion request message to the GSM network, performs a CS domain detach from the GSM network, transmits the voice service in the PS domain that has been established on the LTE network, and then transfers the voice service to the LTE network.

According to the mode switching method provided in this embodiment of the present invention, when the UE is in a single-card dual-standby mode, and in a case in which it is determined that the first network supports the first subsystem, the UE deletes an attachment corresponding to the first service on the second network and disables the second communications mode. In this way, when the UE determines that the first network supports the first subsystem, the UE can switch the first service to the first network, so that in a case in which another service remains unchanged in quality, the first service can be transferred to the first network that can provide a service of better quality, thereby ensuring a transmission rate of the first service and improving user experience.

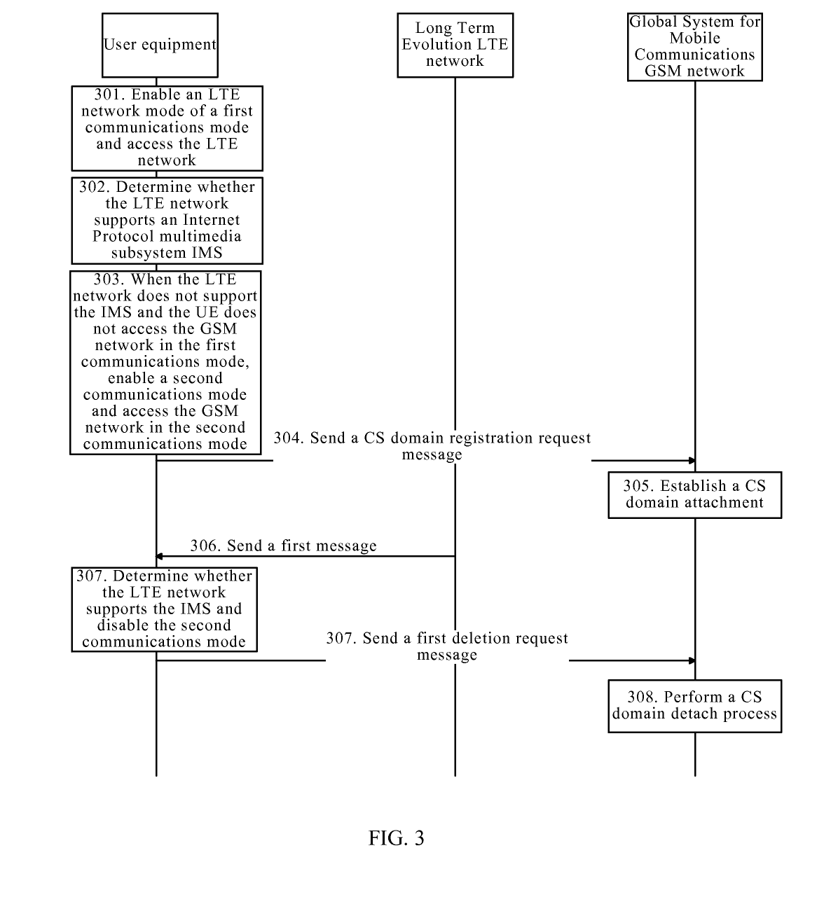

An embodiment of the present invention provides a mode switching method. That a UE transmits voice over LTE on an LTE network is used as an example. In addition, it is assumed that a first network mode of a first communications mode is an LTE network mode; a first subsystem is an IMS; and a second network is a GSM network. As shown in FIG. 3, the method includes:

301. A UE enables an LTE network mode of a first communications mode and accesses an LTE network in the LTE network mode of the first communications mode.

Specifically, when the UE is powered on to perform registration, the LTE network mode of the first communications mode is enabled, and a PS domain is registered with the LTE network in the LTE network mode of the first communications mode.

It should be noted that, although the UE has a single-card dual-standby capability, the UE can access only one network in one communications mode. In this case, the first communications mode of the UE is enabled, a second communications mode is disabled, and the UE accesses the LTE network only in the LTE network mode of the first communications mode.

It should be noted that a voice priority domain of the UE in the LTE network mode of the first communications mode is set as IMS PS domain only. That is, only the voice over LTE is provided by using the LTE network.

In other words, when the UE accesses the LTE network in the LTE network mode of the first communications mode, a voice service of the UE is transmitted only by using the IMS.

In other words, the LTE network in this embodiment of the present invention can provide the voice service only by using the IMS. In this case, the voice service is the voice over LTE and is transmitted as data in a PS domain.

302. When the UE accesses the LTE network in the LTE network mode of the first communications mode, the UE determines whether the LTE network supports the IMS.

Specifically, when the UE accesses the LTE network, the LTE network may send the UE a first message that carries identification information identifying whether the LTE network supports the IMS. The UE may receive the first message and determine, according to the identification information carried in the first message, whether the LTE network supports the IMS.

It should be noted that the LTE network may support the IMS, or may not support the IMS. The LTE network may provide the voice over LTE by using the IMS. When the UE needs to transmit the voice over LTE, the voice over LTE must be transmitted based on the IMS on the LTE network. Therefore, the UE needs to determine whether an LTE network that the UE currently accesses supports the IMS.

Specifically, when the UE updates a tracking area, an updated LTE network sends an updated message related to the LTE network to the UE. The message carries information about whether the LTE network supports the IMS. After receiving the message, the UE determines, according to the information carried in the message, whether the LTE network supports the IMS.

It should be noted that a PS domain of the UE is registered with the LTE network no matter whether the LTE network supports the IMS or not. When the LTE network supports the IMS, voice data of the UE is transmitted in the PS domain by using the IMS; and a data service of the UE is also transmitted in the PS domain. When the LTE network does not support the IMS, the LTE network does not provide the voice service, but the data service of the UE can still be transmitted in the PS domain that is registered with the LTE network.

It should be noted that the first communications mode may further support another network mode. In this case, the UE can access another network in the another network mode of the first communications mode. For example, the first communications mode may further support a GSM network mode. In this case, the UE can access the GSM network in the GSM network mode of the first communications mode, which is not limited in the present invention.

It should be noted that when the UE can access both the LTE network and the GSM network or another network, the UE preferentially accesses the LTE network in this case because the LTE network can provide a better service for the UE when compared with other networks.

303. If the UE determines that the LTE network does not support the IMS and when the UE does not access a GSM network in the first communications mode, the UE enables a second communications mode and accesses the GSM network in the second communications mode.

Specifically, at a present moment, the first network does not support the first subsystem. Therefore, the first network cannot provide transmission of the voice service for the UE, that is, the UE cannot acquire data of the voice service by using the LTE network. In this case, because the UE has the single-card dual-standby capability, in a case in which the UE does not access the GSM network in the first communications mode, the UE can enable the second communications mode and accesses, in the second communications mode, the GSM network that supports establishment of a CS domain attachment, so as to acquire the data of the voice service by using the GSM network.

It should be noted that the UE can access the GSM network in only one communications mode. When the UE can separately access the GSM network in both communications modes, the UE needs to disable a function of accessing the GSM network in one of the two communication modes. Therefore, when the UE can access the GSM network in the first communications mode, the UE cannot simultaneously access the GSM network in the second communications mode. In other words, before the UE accesses the GSM network in the second communications mode, it must be determined that the UE does not access the GSM network in the first communications mode.

It should be noted that a process of enabling the second communications mode by the UE is a process of switching from a single-card single-standby mode to a single-card dual-standby mode by the UE.

It should be noted that if the UE is in the LTE network mode of the first communications mode and determines that the LTE network supports the IMS, in this case, the UE does not need to make any change because the UE has transmitted the voice service by using the IMS.

It should be noted that after the UE determines that the LTE network does not support the IMS, although the UE cannot transmit the voice over LTE by using the LTE network, the UE can transmit data of another service by using the LTE network. For example, the data service can still be transmitted in the PS domain by using the LTE network.

It should be noted that when the UE does not access the GSM network in the first communications mode, that the UE enables the second communications mode and accesses the GSM network in the second communications mode may be classified into two cases.

In the first case, the second network mode of the first communications mode of the UE is a TD-SCDMA network mode and the GSM network mode. In this case, in order to access the GSM network in the second communications mode, it is necessary to disable the GSM network mode in the second network mode of the first communications mode, so as to ensure that the UE can access the GSM network in the second communications mode.

It should be noted that the UE may further disable both the TD-SCDMA network mode and the GSM network mode in the second network mode of the first communications mode, which can also ensure that the UE can access the GSM network in the second communications mode.

In other words, the UE may access the second network in the second network mode of the first communications mode. In this case, in order to access the GSM network in the second communications mode, the UE needs to disable a function of accessing the GSM network in the second network mode of the first communications mode, that is, the UE disables the second network mode of the first communications mode, so as to ensure that the UE cannot access the GSM network in the first communications mode. After disabling the second network mode of the first communications mode, the UE can access the GSM network in the second communications mode.

Further, the disabling, by the UE, the second network mode of the first communications mode may be specifically as follows: The UE removes a frequency range corresponding to the second network mode from a frequency range searched by the UE in the first communications mode.

It should be noted that the second network mode of the first communications mode of the UE may further be a WCDMA network mode and the GSM network mode or another network mode including the GSM network mode, which is not limited in the present invention.

In the second case, the second network mode of the first communications mode of the UE is a TD-SCDMA network mode. In this case, the UE does not access the GSM network in the second network mode of the first communications mode. The UE may directly enable the second communications mode and access the GSM network in the second communications mode.

It should be noted that the second network mode of the first communications mode of the UE may further be a WCDMA network mode or another network mode that does not include the GSM network mode, which is not limited in the present invention.

It should be noted that the UE may also disable one network mode of the first communications mode, then enable the second communications mode, and access the GSM network in the second communications mode, which is not limited in the present invention.

304. The UE sends a CS domain registration request message to the GSM network; and the GSM network receives the CS domain registration request message sent by the UE.

The CS domain registration request message carries first identification information, so that the GSM network establishes a CS domain attachment according to the first identification information.

It should be noted that the UE transfers the voice service to the second communications mode; however, another service except the voice service is still transmitted by using the LTE network in the first communications mode.

Specifically, after accessing the GSM network, the UE needs to instruct the GSM network to establish a transmission link used for transmitting the voice service. In this case, the UE sends the CS domain registration request message to the GSM network, so as to transfer the voice service to the GSM network.

Specifically, when the UE transmits the voice service by using the LTE network, the data of the voice service cannot be transmitted by using the LTE network because the LTE network does not support the IMS. If the second network is the GSM network and the UE can access the GSM network in the second communications mode, in this case, the UE can access the GSM network in the second communications mode when the UE cannot access the GSM network in the first communications mode. After the UE accesses the GSM network, the UE sends the CS domain registration request message that carries the first identification information to the GSM network. The GSM network may establish, according to the received CS domain registration request message, a CS domain attachment corresponding to the voice service, so that the GSM network can provide the voice service for the UE. In this case, the UE may further transmit another data service in the PS domain by using the LTE network.

305. The GSM network establishes, according to received first identification information, a CS domain attachment corresponding to a voice service on the GSM network.

Specifically, after receiving the CS domain registration request message, the GSM establishes the transmission link used for transmitting the voice service on the GSM network according to the first identification information carried in the CS domain registration request message, that is, the CS domain attachment corresponding to the voice service on the GSM network is established.

It should be noted that after the GSM network establishes the CS domain attachment, the voice service of the UE is transmitted by using the GSM network, but the data service is still transmitted by using the LTE network in the LTE network mode of the first communications mode.

It should be noted that when the UE is in a state of accessing the LTE network in the LTE network mode of the first communications mode and accessing the GSM network in the second communications mode, and if the LTE network that the UE accesses in the LTE network mode of the first communications mode changes due to movement of the UE or another factor, that is, the UE accesses an LTE network in a neighboring cell, in this case, steps 306 to 308 are performed.

It should be noted that an LTE network in steps 306 to 308 is updated LTE, that is, the LTE network in the neighboring cell.

306. When the UE is in a state of accessing the LTE network in the LTE network mode of the first communications mode and accessing the GSM network in the second communications mode, the LTE network sends a first message to the UE; and after receiving the first message, the UE determines, according to identification information carried in the first message, whether the LTE network supports the IMS.

It should be noted that with comparison between the voice service provided by the UE by using the IMS on the LTE network and the voice service provided by using the GSM network, the voice service provided by the UE by using the IMS on the LTE network is far more superior to the voice service provided by using the GSM network in quality. Therefore, when the UE is in a dual standby mode, the UE needs to determine whether the LTE network supports the IMS, so that the voice service can be transferred to the LTE network in time when the LTE network supports the IMS.

In this case, the UE accesses the LTE network in the first network mode of the first communications mode and accesses the GSM network in the second communications mode. That is, the PS domain of the UE is registered with the LTE network to provide the data service; and a CS domain of the UE is registered with the GSM network to provide the voice service.

Specifically, when the UE updates a tracking area, an updated LTE network sends a message to the UE. The message carries information about whether the LTE network supports the IMS. After receiving the message, the UE determines, according to the information carried in the received message, whether the LTE network supports the IMS.

307. If the UE determines that the LTE network supports the IMS, the UE sends a first deletion request message to the GSM network; the GSM network receives the first deletion request message sent by the UE; and the UE disables the second communications mode.

The first deletion request message is used by the UE to instruct the GSM network to delete the CS domain attachment of the UE on the GSM network.

Specifically, when the UE determines that the LTE network supports the IMS, the LTE network can provide the voice service for the UE by using the IMS. Because the voice service provided by the LTE network for the UE by using the IMS is far more superior to the voice service provided by the GSM network for the UE in quality, in this case, the UE may switch the voice service to the LTE network, and the data related to the voice service of the UE is transmitted over the LTE network by using the IMS. In addition, the UE needs to trigger deletion of the CS domain attachment on the GSM network, where the deletion is performed by the GSM network. In this case, the UE may send the GSM network the first deletion request message that instructs the GSM network to delete the CS domain attachment corresponding to the voice service. The UE disables the second communications mode, so as to switch to a case in which the UE accesses the LTE network only in the LTE network mode of the first communications mode.

It should be noted that a process of sending the first deletion request message to the GSM network and disabling the second communications mode by the UE is a process of switching from a single-card dual-standby mode to a single-card single-standby mode by the UE.

In other words, in a case in which the UE determines that the LTE network supports the IMS and disables the second communications mode, the UE sends the first deletion request message to the GSM network, so as to perform a CS domain detach from the GSM network. In addition, the UE transmits the voice service by using the PS domain attachment on the LTE network and then transfers the voice service to the LTE network.

308. The GSM network performs, according to the first deletion request message, a CS domain detach process corresponding to the voice service.

Specifically, after receiving the first deletion request message, the GSM network deletes the CS domain attachment corresponding to the voice service on the GSM network, that is, the transmission link that is registered with the CS domain and used for transmitting the voice service is deleted.

According to the mode switching method provided in this embodiment of the present invention, when determining that the LTE network does not support the IMS, the UE enables the second communications mode and transfers the voice service to the GSM network. In addition, when the UE is in a single-card dual-standby mode and determines that the LTE network supports the IMS, the UE deletes the CS domain attachment corresponding to the voice service on the GSM network, disables the second communications mode, and transfers the voice service to the LTE network. In this way, the UE can implement quick switching between the single-card single-standby mode and the single-card dual-standby mode, so that a high-quality voice service can be provided as much as possible in a case in which quality of the data service is unchanged, thereby improving user experience.

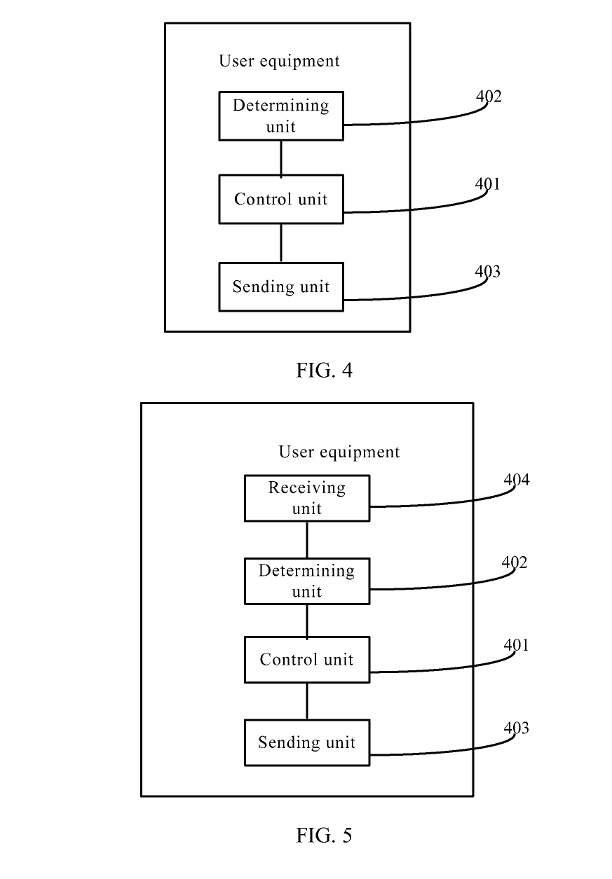

As shown in FIG. 4, FIG. 4 is a schematic functional diagram of a UE according to an embodiment of the present invention. The UE includes: a control unit 401, a determining unit 402, and a sending unit 403.

The determining unit 402 is configured to, when the UE is in a state of accessing a first network in a first network mode of a first communications mode, determine whether the first network supports a first subsystem.

The first network mode of the first communications mode is used for supporting access of the UE to the first network. The first network provides a first service for the UE by using the first subsystem.

Optionally, the first network mode includes a Long Term Evolution LTE network mode. The first network includes an LTE network. The first subsystem includes an Internet Protocol multimedia subsystem IMS. The first service includes a voice service.

In this case, the determining unit 402 is specifically configured to, when the UE is in the LTE network mode of the first communications mode, determine whether the LTE network supports the IMS.

It should be noted that the UE has a single-card dual-standby capability. In other words, the UE has a capability of simultaneously working in two communications modes, that is, the first communications mode and a second communications mode. The UE may separately support different networks in the two communications modes. The UE may separately transmit different types of services over the different networks that the UE accesses in the two communications modes. Certainly, the UE may also access only one network in one of the two communications modes.

It should be noted that the first network may support the first subsystem, or may not support the first subsystem.

It should be noted that when the first network supports the first subsystem, the first network provides the first service only by using the first subsystem.

It should be noted that the LTE network may support the IMS, or may not support the IMS. When the UE needs to transmit voice over LTE, the determining unit 402 needs to determine whether the LTE network that the UE currently accesses supports the IMS because the voice over LTE must be transmitted based on the IMS on the LTE network.

It should be noted that the LTE network in this embodiment of the present invention can provide the voice service only by using the IMS. In this case, the voice service is the voice over LTE and is transmitted as data in a PS (Packet Switched, packet switched) domain.

It should be noted that a PS domain of the UE is registered with the LTE network no matter whether the LTE network supports the IMS or not. When the LTE network supports the IMS, voice data of the UE is transmitted in the PS domain by using the IMS; and a data service of the UE is also transmitted in the PS domain. When the LTE network does not support the IMS, the LTE network does not provide the voice service, but the data service of the UE can still be transmitted in the PS domain that is registered with the LTE network.

The control unit 401 is configured to, when the determining unit 402 determines that the first network does not support the first subsystem and the UE does not access a second network in the first communications mode, enable the second communications mode and access the second network in the second communications mode.

In addition to the first network, the second network supports establishment of a first attachment. The first attachment is used for providing the first service for the UE over the second network.

Specifically, at a present moment, the first network does not support the first subsystem. Therefore, the first network cannot provide transmission of the first service for the UE, that is, the UE cannot acquire data related to the first service by using the first network. In this case, because the UE has the single-card dual-standby capability, in a case in which the control unit 401 does not access the second network in the first communications mode, the control unit 401 can enable the second communications mode and access, in the second communications mode, the second network that supports the establishment of the first attachment, so as to acquire the data related to the first service by using the second network.

It should be noted that the control unit 401 can access a certain network in only one communications mode. When the control unit 401 can separately access the network in two communications modes, the control unit 401 needs to disable a function of accessing the network in one of the two communication modes. Therefore, when the control unit 401 can access the second network in the first communications mode, the control unit 401 cannot access the second network in the second communications mode. In other words, before the control unit 401 accesses the second network in the second communications mode, it must be determined that the control unit 401 does not access the second network in the first communications mode.

It should be noted that a process of enabling the second communications mode by the control unit 401 is a process of switching from a single-card single-standby mode to a single-card dual-standby mode by the UE.

It should be noted that if the UE is in the first network mode of the first communications mode and the determining unit 402 determines that the first network supports the first subsystem, in this case, the UE does not need to make any change because the UE has transmitted the first service by using the first subsystem.

Further, the first attachment includes a CS domain attachment.

Further, when the first network mode is the LTE network mode, in this case, the LTE network can provide the voice service only by using the IMS. If the UE determines that the LTE network does not support the IMS, the UE cannot transmit the voice over LTE by using the LTE network.

It should be noted that after the UE determines that the LTE network does not support the IMS, although the UE cannot transmit the voice over LTE by using the LTE network, the UE can transmit data of another service by using the LTE network. For example, the data service can still be transmitted in the PS domain by using the LTE network.

Further, that the control unit 401 is configured to, when the UE does not access the second network in the first communications mode, enable the second communications mode and access the second network in the second communications mode may be classified into two cases.

In the first case, the control unit 401 is specifically configured to, when the first communications mode provides the second network mode, disable the second network mode of the first communications mode, enable the second communications mode, and access the second network in the second communications mode.

The second network mode of the first communications mode is used for supporting access of the UE to the second network.

In other words, the control unit 401 can access the second network in the second network mode of the first communications mode. In this case, in order to access the second network in the second communications mode, the control unit 401 needs to disable a function of accessing the second network in the second network mode of the first communications mode. That is, the control unit 401 disables the second network mode of the first communications mode, so as to ensure that the control unit 401 cannot access the second network in the first communications mode. After disabling the second network mode of the first communications mode, the control unit 401 can access the second network in the second communications mode.

Further, the disabling, by the control unit 401, the second network mode of the first communications mode may be specifically as follows: The control unit 401 removes a frequency range corresponding to the second network mode from a frequency range searched in the first communications mode.

It should be noted that the control unit 401 may access a different type of network in the second network mode of the first communications mode. When the control unit 401 disables the second network mode of the first communications mode, a type of the second network that the control unit 401 accesses in the second communications mode may be the same as a type of a network that the control unit 401 accesses in the second network mode of the first communications mode.

For example, a network that the control unit 401 may access in the second network mode of the first communications mode may be a TD-SCDMA network or a GSM network. After the control unit 401 disables the second network mode of the first communications mode, the second network that the control unit 401 accesses in the second communications mode may be a TD-SCDMA network or a GSM network.

In the second case, the control unit 401 is specifically configured to, when the first communications mode does not provide the second network mode, enable the second communications mode and access the second network in the second communications mode.

In other words, the control unit 401 cannot access the second network in the first communications mode. That is, the second network is not included in networks that the control unit 401 can access in the first communications mode. In this case, the control unit 401 may directly enable the second communications mode and access the second network in the second communications mode.

It should be noted that the control unit 401 may also disable one network mode of the first communications mode, then enable the second communications mode, and access the second network in the second communications mode, which is not limited in the present invention.

For example, the networks that the control unit 401 can access in the first communications mode include the LTE network, a TD-SCDMA network, and a GSM network. If the second network is a WCDMA network, the control unit 401 may directly enable the second communications mode and access the WCDMA network in the second communications mode.

Certainly, the control unit 401 may disable one network mode of the first communications mode. For example, the control unit 401 disables a GSM network mode of the first communications mode to increase a type of network that the UE accesses in the second communications mode.

Further, the second network includes: the GSM network, the TD-SCDMA network, or the WCDMA network.

Further, when the first communications mode provides the second network mode, the second network mode includes: the GSM network mode, the TD-SCDMA network mode, or the WCDMA network mode.

The sending unit 403 is further configured to send a first registration request message to the second network.

The first registration request message carries first identification information, so that the second network establishes the first attachment according to the first identification information.

It should be noted that the UE transfers the first service to the second communications mode; however, another service except the first service is still transmitted by using the first network in the first communications mode.

Specifically, after accessing the second network, the UE needs to instruct the second network to establish a transmission link used for transmitting data related to the first service. In this case, the sending unit 403 sends the first registration request message to the second network.

The first registration request message includes a CS domain registration request message.

The sending unit 403 is specifically configured to send the CS domain registration request message to the second network.

Exemplarily, when the UE needs to transmit the voice service by using the LTE network, the LTE network cannot transmit the voice service because the LTE network does not support the IMS. If the second network is the GSM network and the control unit 401 can access the GSM network in the second communications mode, in this case, the control unit 401 can access the GSM network in the second communications mode when the control unit 401 cannot access the GSM network in the first communications mode. After the control unit 401 accesses the GSM network, the sending unit 403 sends the CS domain registration request message carrying the first identification information to the GSM network. The GSM network may establish, according to the received CS domain registration request message, a CS domain attachment corresponding to the voice service, so that the GSM network can provide the voice service for the UE. In this case, the UE may further transmit another data service in the PS domain by using the LTE network.

Further, the control unit 401 is further configured to enable the first network mode of the first communications mode and access the first network in the first network mode of the first communications mode.

The determining unit 402 is further configured to, when the UE is in a state of accessing the first network in the first network mode of the first communications mode and accessing the second network in the second communications mode, determine whether the first network supports the first subsystem.

It should be noted that, in this embodiment of the present invention, the first service is transmitted over the second network; and another service except the first service is transmitted over the first network.

It should be noted that the first network may support the first subsystem, or may not support the first subsystem.

It should be noted that when the first network supports the first subsystem, the first network provides the first service only by using the first subsystem.

It should be noted that with comparison between the first service provided by the first network for the UE by using the first subsystem and the first service provided by the second network for the UE, the first service provided by the first network for the UE by using the first subsystem is superior to the first service provided by the second network for the UE in quality. Therefore, the determining unit 402 needs to detect whether the first network can provide the first service for the UE, so that when it is detected that the first network supports the first subsystem, the first service can be timely switched to the first network that can provide better quality.

Exemplarily, it is assumed that the first network is the LTE network, the second network is the GSM network, the first subsystem is the IMS, and the first service is the voice service. In this case, the UE accesses the LTE network in the first network mode of the first communications mode and accesses the GSM network in the second communications mode. That is, the PS domain of the UE is registered with the LTE network to provide the data service; and a CS domain of the UE is registered with the GSM network to provide the voice service.

The sending unit 403 is further configured to send a first deletion request message to the second network when the determining unit 402 determines that the first network supports the first subsystem.

The first deletion request message is used for instructing the second network to delete a first attachment of the UE on the second network.

Specifically, when the determining unit 402 determines that the first network supports the first subsystem, the first network can provide the first service for the UE by using the first subsystem. Because the first service provided by the first network for the UE by using the first subsystem is superior to the first service provided by the second network for the UE in quality, in this case, the UE can switch the first service to the first network, so that the data related to the first service of the UE is transmitted over the first network by using the first subsystem. In addition, the UE needs to trigger a deletion of an attachment corresponding to the first service on the second network, where the deletion is performed by the second network. In this case, the sending unit 403 may send the second network the first deletion request message that instructs the second network to delete the first attachment.

Further, in a case in which the determining unit 402 determines that the LTE network supports the IMS and disables the second communications mode, the sending unit 403 sends the first deletion request message to the GSM network, performs a CS domain detach from the GSM network, transmits the voice service in the PS domain established on the LTE network, and then transfers the voice service to the LTE network.

The control unit 401 is further configured to disable the second communications mode after the sending unit 403 sends the first deletion request message to the second network.

Specifically, after the sending unit 403 sends the first deletion request message to the second network, so that the second network deletes the attachment corresponding to the first service, the control unit 401 disables the second communications mode, so as to switch to a case in which the control unit 401 accesses the first network only in the first network mode of the first communications mode.

It should be noted that a process of sending the first deletion request message to the second network by the sending unit 403 and disabling the second communications mode by the control unit 401 is a process of switching from the single-card dual-standby mode to the single-card single-standby mode by the UE.

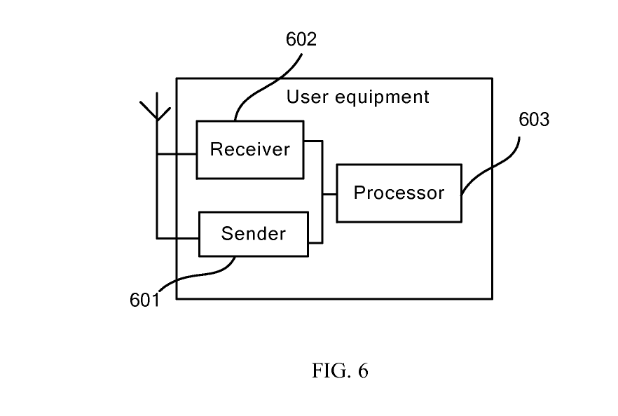

Further, as shown in FIG. 5, the foregoing UE further includes:

a receiving unit 404, configured to receive a first message sent by the first network.

The first message carries identification information about whether the first network supports the first subsystem.

In this case, the determining unit 402 is specifically configured to, according to the identification information carried in the first message received by the receiving unit 404, determine whether the first network supports the first subsystem.

In other words, when the UE accesses the first network in the first network mode of the first communications mode, the receiving unit 404 receives the first message that is sent by the first network and carries the identification information about whether the first network supports the first subsystem. After the receiving unit 404 receives the identification information, the determining unit 402 can determine, according to the identification information, whether the first network supports the first subsystem.

Exemplarily, it is assumed that the first network is the LTE, the second network is the GSM network, the first subsystem is the IMS, and the first service is the voice service. In this case, the UE accesses the LTE network in the first network mode of the first communications mode and accesses the GSM network in the second communications mode. That is, the PS domain of the UE is registered with the LTE network to provide the data service; and the CS domain of the UE is registered with the GSM network to provide the voice service.

Further, when the UE updates a tracking area, an updated LTE network sends a message to the UE. The message carries information about whether the LTE network supports the IMS. After the receiving unit 404 receives the message, the determining unit 402 can determine, according to the information carried in the message, whether the LTE network supports the IMS.

According to the UE provided in this embodiment of the present invention, when determining that the LTE network does not support the IMS, the UE enables the second communications mode and transfers the voice service to the GSM network. In addition, when the UE is in a single-card dual-standby mode and determines that the LTE network supports the IMS, the UE deletes the attachment corresponding to the voice service on the GSM network, disables the second communications mode, and transfers the voice service to the LTE network. In this way, the UE can implement quick switching between the single-card single-standby mode and the single-card dual-standby mode, so that a high-quality voice service can be provided as much as possible in a case in which quality of the data service is unchanged, thereby improving user experience.

As shown in FIG. 6, FIG. 6 is a schematic structural diagram of a UE according to an embodiment of the present invention. The UE includes: a sender 601, a receiver 602, and a processor 603.

The processor 603 is configured to, when the UE is in a first network mode of a first communications mode, determine whether a first network supports a first subsystem.

The first network mode of the first communications mode is used for supporting access of the UE to the first network. The first network provides a first service for the UE by using the first subsystem.

Optionally, the first network mode includes a Long Term Evolution LTE network mode. The first network includes an LTE network. The first subsystem includes an Internet Protocol multimedia subsystem IMS. The first service includes a voice service.

In this case, the processor 603 is specifically configured to, when the UE is in the LTE network mode of the first communications mode, determine whether the LTE network supports the IMS.

It should be noted that the UE has a single-card dual-standby capability. In other words, the UE has a capability of simultaneously working in two communications modes, that is, the first communications mode and a second communications mode. The UE may separately support different networks in the two communications modes. The UE may separately transmit different types of services over the different networks that the UE accesses in the two communications modes. Certainly, the UE may also access only one network in one of the two communications modes.

It should be noted that the first network may support the first subsystem, or may not support the first subsystem.

It should be noted that when the first network supports the first subsystem, the first network provides the first service only by using the first subsystem.

It should be noted that the LTE network in this embodiment of the present invention can provide the voice service only by using the IMS. In this case, the voice service is voice over LTE and is transmitted as data in a PS (Packet Switched, packet switched) domain.

It should be noted that a PS domain of the UE is registered with the LTE network no matter whether the LTE network supports the IMS or not. When the LTE network supports the IMS, voice data of the UE is transmitted in the PS domain by using the IMS; and a data service of the UE is also transmitted in the PS domain. When the LTE network does not support the IMS, the LTE network does not provide the voice service, but the data service of the UE can still be transmitted in the PS domain that is registered with the LTE network.

It should be noted that when the LTE network in this embodiment of the present invention supports the IMS, although registration with a CS domain is provided, the voice over LTE can be provided only by using the IMS. In this case, the voice service is transmitted as data in the PS domain.

The processor 603 is configured to, when it is determined that the first network does not support the first subsystem and the UE does not access a second network in the first communications mode, enable the second communications mode and access the second network in the second communications mode.

In addition to the first network, the second network supports establishment of a first attachment. The first attachment is used for providing the first service for the UE over the second network.

Specifically, at a present moment, the first network does not support the first subsystem. Therefore, the first network cannot provide transmission of the first service for the UE, that is, the UE cannot acquire data of the first service by using the first network. In this case, because the UE has the single-card dual-standby capability, in a case in which the processor 603 does not access the second network in the first communications mode, the processor 603 can enable the second communications mode and access, in the second communications mode, the second network that supports the establishment of the first attachment, so as to acquire the data of the first service by using the second network.

It should be noted that the processor 603 can access a certain network in only one communications mode. When the processor 603 can access a certain network separately in two communications modes, the processor 603 needs to disable a function of accessing the network in one of the two communications modes. Therefore, when the processor 603 can access the second network in the first communications mode, the processor 603 cannot access the second network in the second communications mode. In other words, before the processor 603 accesses the second network in the second communications mode, it must be determined that the processor 603 does not access the second network in the first communications mode.

It should be noted that a process of enabling the second communications mode by the processor 603 is a process of switching from a single-card single-standby mode to a single-card dual-standby mode by the UE.

It should be noted that if the UE is in the first network mode of the first communications mode and determines that the first network supports the first subsystem, in this case, the UE has transmitted the first service by using the first subsystem. Therefore, the UE does not need to make any change.

Further, the first attachment includes a CS domain attachment.

Further, when the first network mode is the LTE network mode, in this case, the LTE network can provide the voice service only by using the IMS. If the UE determines that the LTE network does not support the IMS, the UE cannot transmit the voice over LTE by using the LTE network.

It should be noted that after the UE determines that the LTE network does not support the IMS, although the UE cannot transmit the voice over LTE by using the LTE network, the UE can transmit data of another service by using the LTE network. For example, the data service can still be transmitted in the PS domain by using the LTE network.

Further, that the processor 603 is configured to, when the UE does not access the second network in the first communications mode, enable the second communications mode and access the second network in the second communications mode may be classified into two cases.

In the first case, the processor 603 is specifically configured to, when the first communications mode provides a second network mode, disable the second network mode of the first communications mode, enable the second communications mode, and access the second network in the second communications mode.

The second network mode of the first communications mode is used for supporting access of the UE to the second network.

In other words, the processor 603 may access the second network in the second network mode of the first communications mode. In this case, in order to access the second network in the second communications mode, the processor 603 needs to disable a function of accessing the second network in the second network mode of the first communications mode, that is, the processor 603 disables the second network mode of the first communications mode, so as to ensure that the processor 603 cannot access the second network in the first communications mode. After disabling the second network mode of the first communications mode, the processor 603 can access the second network in the second communications mode.

Further, the disabling, by the processor 603, the second network mode of the first communications mode may be specifically: removing a frequency range corresponding to the second network mode from a searching frequency range in the first communications mode.

It should be noted that the processor 603 may access different types of networks in the second network mode of the first communications mode. When the processor 603 disables the second network mode of the first communications mode, a type of the second network that the processor 603 accesses in the second communications mode may be the same as a type of a network that the processor 603 accesses in the second network mode of the first communications mode.

For example, a network that the processor 603 may access in the second network mode of the first communications mode is a TD-SCDMA network or a GSM network. After the processor 603 disables the second network mode of the first communications mode, the second network that the processor 603 accesses in the second communications mode may be the TD-SCDMA network or the GSM network.

In the second case, the processor 603 is specifically configured to, when the first communications mode does not provide the second network mode, enable the second communications mode and access the second network in the second communications mode.

In other words, the processor 603 cannot access the second network in the first communications mode, that is, the second network is not included in networks that the processor 603 can access in the first communications mode. In this case, the processor 603 can directly enable the second communications mode and access the second network in the second communications mode.

It should be noted that the processor 603 may also disable one network mode of the first communications mode, then enable the second communications mode, and access the second network in the second communications mode, which is not limited in the present invention.

For example, networks that the processor 603 can access in the first communications mode include the LTE network, a TD-SCDMA network, and a GSM network. If the second network is a WCDMA network, the processor 603 can directly enable the second communications mode and access the WCDMA network in the second communications mode.

Certainly, the processor 603 may disable one network mode of the first communications mode. For example, the processor 603 disables a GSM network mode of the first communications mode to increase a types of a network that the UE accesses in the second communications mode.

Further, the second network includes the GSM network, the TD-SCDMA network, or the WCDMA network.

Further, when the first communications mode provides the second network mode, the second network mode includes: the GSM network mode, the TD-SCDMA network mode, or the WCDMA network mode.

The sender 601 is further configured to send a first registration request message to the second network.

The first registration request message carries first identification information, so that the second network establishes the first attachment according to the first identification information.

It should be noted that the UE transfers the first service to the second communications mode; however, another service except the first service is still transmitted by using the first network in the first communications mode.

Specifically, after accessing the second network, the UE needs to instruct the second network to establish a transmission link used for transmitting data related to the first service. In this case, the sender 601 sends the first registration request message to the second network.

The first registration request message includes a CS domain registration request message.

The sender 601 is specifically configured to send the CS domain registration request message to the second network.

Exemplarily, when the UE needs to transmit the voice service by using the LTE network, the LTE network cannot transmit the voice service because the LTE network does not support the IMS. If the second network is the GSM network and the processor 603 can access the GSM network in the second communications mode, in this case, the processor 603 can access the GSM network in the second communications mode when the processor 603 cannot access the GSM network in the first communications mode. After the processor 603 accesses the GSM network, the sender 601 sends the CS domain registration request message carrying the first identification information to the GSM network. The GSM network may establish, according to the received CS domain registration request message, a CS domain attachment corresponding to the voice service, so that the GSM network can provide the voice service for the UE. In this case, the UE may further transmit another data service in the PS domain by using the LTE network.

Further, the processor 603 is further configured to enable the first network mode of the first communications mode and access the first network in the first network mode of the first communications mode.

The processor 603 is further configured to, when the UE is in a state of accessing the first network in the first network mode of the first communications mode and accessing the second network in the second communications mode, determine whether the first network supports the first subsystem.

It should be noted that, in this embodiment of the present invention, the first service is transmitted over the second network; and another service except the first service is transmitted over the first network.

It should be noted that the first network may support the first subsystem, or may not support the first subsystem.

It should be noted that when the first network supports the first subsystem, the first network provides the first service only by using the first subsystem.

It should be noted that with comparison between the first service provided by the first network for the UE by using the first subsystem and the first service provided by the second network for the UE, the first service provided by the first network for the UE by using the first subsystem is superior to the first service provided by the second network for the UE in quality. Therefore, the processor 603 needs to detect whether the first network can provide the first service for the UE, so that when it is detected that the first network supports the first subsystem, the first service can be timely switched to the first network that can provide better quality.

Exemplarily, it is assumed that the first network is the LTE, the second network is the GSM network, the first subsystem is the IMS, and the first service is the voice service. In this case, the UE accesses the LTE network in the first network mode of the first communications mode and accesses the GSM network in the second communications mode. That is, the PS domain of the UE is registered with the LTE network to provide the data service; and the CS domain of the UE is registered with the GSM network to provide the voice service.

Further, when the UE updates a tracking area, an updated LTE network sends a message to the UE. The message carries information about whether the LTE network supports the IMS. In this case, the processor 603 can determine, according to the information about whether the LTE network supports the IMS carried in the message, whether the LTE network supports the IMS.

The sender 601 is further configured to send a first deletion request message to the second network when the processor 603 determines that the first network supports the first subsystem.

The first deletion request message is used for instructing the second network to delete the first attachment.

Specifically, when the processor 603 determines that the first network supports the first subsystem, the first network can provide the first service for the UE by using the first subsystem. Because the first service provided by the first network for the UE by using the first subsystem is superior to the first service provided by the second network for the UE in quality, in this case, the UE can switch the first service to the first network, so that the data related to the first service of the UE is transmitted over the first network by using the first subsystem. In addition, the UE needs to trigger a deletion of an attachment corresponding to the first service on the second network, where the deletion is performed by the second network. In this case, the sender 601 may send the second network the first deletion request message that instructs the second network to delete the attachment corresponding to the first service.

The processor 603 is further configured to disable the second communications mode after the sender 601 sends the first deletion request message to the second network.

Specifically, after the sender 601 sends the first deletion request message to the second network, so that the second network deletes the attachment corresponding to the first service, the processor 603 disables the second communications mode, so as to switch to a case in which the processor 603 accesses the first network only in the first network mode of the first communications mode.

It should be noted that a process of sending the first deletion request message to the second network by the sender 601 and disabling the second communications mode by the processor 603 is a process of switching from the single-card dual-standby mode to the single-card single-standby mode by the UE.

The receiver 602 is configured to receive a first message sent by the first network.

The first message carries identification information about whether the first network supports the first subsystem.

In this case, the processor 603 is specifically configured to, according to the identification information carried in the first message received by the receiver 602, determine whether the first network supports the first subsystem.

In other words, when the UE accesses the first network in the first network mode of the first communications mode, the receiver 602 receives the first message that is sent by the first network and carries the identification information about whether the first network supports the first subsystem. After the receiver 602 receives the identification information, the processor 603 can determine, according to the identification information, whether the first network supports the first subsystem.

Further, in a case in which the processor 603 determines that the LTE network supports the IMS and disables the second communications mode, the sender 601 sends the first deletion request message to the GSM network, performs a CS domain detach from the GSM network, transmits the voice service in the PS domain that has been established on the LTE network, and then transfers the voice service to the LTE network.

According to the UE provided in this embodiment of the present invention, when determining that the LTE network does not support the IMS, the UE enables the second communications mode and transfers the voice service to the GSM network. In addition, when the UE is in the single-card dual-standby mode and determines that the LTE network supports the IMS, the UE deletes the attachment corresponding to the voice service on the GSM network, disables the second communications mode, and transfers the voice service to the LTE network. In this way, the UE can implement quick switching between the single-card single-standby mode and the single-card dual-standby mode, so that a high-quality voice service can be provided as much as possible in a case in which quality of the data service is unchanged, thereby improving user experience.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. Furthermore, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. A part or all of the units may be selected according to an actual need to achieve the objectives of the solutions of the embodiments.

In addition, functional units in the embodiments of the present invention may be integrated into one processing unit, or each of the units may exist alone physically, or two or more units are integrated into one unit. The integrated unit may be implemented by hardware in addition to a software functional unit, or by hardware only.

The integrated unit implemented in the form of software functional unit may be stored in a computer readable storage medium. The software functional unit is stored in a storage medium, and includes several instructions for instructing a computer device (which may be a personal computer, a server, a network device, or the like) to perform all or a part of the steps of the methods described in the embodiments of the present invention. The foregoing storage medium includes any medium that can store program code, such as a USB flash drive, a removable hard disk, a read-only memory (Read-Only Memory, ROM), a random access memory (Random Access Memory, RAM), a magnetic disk, or an optical disc.

Finally, it should be noted that the foregoing embodiments are merely intended for describing the technical solutions of the present invention other than limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present invention.

What is claimed is:

1. A mode switching method, comprising:
determining, by a UE, when the user equipment UE is in a state of accessing a first network in a first network mode of a first communications mode, whether the first network supports a first subsystem, wherein the first network mode of the first communications mode is used for supporting access of the UE to the first network, and the first network provides a first service for the UE by using the first subsystem;
enabling, by the UE, if the UE determines that the first network does not support the first subsystem and when the UE does not access a second network in the first communications mode, a second communications mode and accessing the second network in the second communications mode, wherein in addition to the first network, the second network supports establishment of a first attachment, and the first attachment is used for providing the first service for the UE over the second network; and
sending, by the UE, a first registration request message to the second network, wherein the first registration request message carries first identification information, so that the second network establishes the first attachment according to the first identification information.

2. The method according to claim 1, wherein the enabling, by the UE, if the UE determines that the first network does not support the first subsystem and when the UE does not access a second network in the first communications mode, a second communications mode and accessing the second network in the second communications mode comprises:
when the first communications mode provides a second network mode, disabling, by the UE, the second network mode of the first communications mode, wherein the second network mode of the first communications mode is used for supporting access of the UE to the second network; and
enabling, by the UE, the second communications mode and accessing the second network in the second communications mode.

3. The method according to claim 1, wherein the enabling, by the UE, if the UE determines that the first network does not support the first subsystem and when the UE does not access a second network in the first communications mode, a second communications mode and accessing the second network in the second communications mode comprises:
when the first communications mode does not provide a second network mode, enabling, by the UE, the second communications mode and accessing the second network in the second communications mode.

4. The method according to claim 1, before the determining, by the UE, when the user equipment UE is in the first network mode of the first communications mode, whether the first network supports the first subsystem, further comprising:
enabling, by the UE, the first network mode of the first communications mode and accessing the first network in the first network mode of the first communications mode.

5. The method according to claim 1, further comprising:
when the UE is in a state of accessing the first network in the first network mode of the first communications mode and accessing the second network in the second communications mode, determining, by the UE, whether the first network supports the first subsystem; and
if the UE determines that the first network supports the first subsystem, sending, by the UE, a first deletion request message to the second network and disabling the second communications mode, wherein the first deletion request message is used by the UE to instruct the second network to delete the first attachment.

6. The method according to claim 1, wherein the determining, by the UE, whether the first network supports a first subsystem comprises:
receiving, by the UE, a first message sent by the first network, wherein the first message carries identification information about whether the first network supports the first subsystem; and
determining, by the UE according to the identification information carried in the first message, whether the first network supports the first subsystem.

7. The method according to claim 1, wherein:
the first network mode comprises a Long Term Evolution LTE network mode, the first network comprises an LTE network, the first subsystem comprises an Internet Protocol multimedia subsystem IMS, and the first service comprises a voice service;
the determining, by the UE, when the user equipment UE is in the first network mode of the first communications mode, whether the first network supports a first subsystem comprises:
when the user equipment UE is in the LTE network mode of the first communications mode, determining, by the UE, whether the LTE network supports the IMS, wherein
the first attachment comprises a CS domain attachment; and
the first registration request message comprises a CS domain registration request message; and
the sending, by the UE, a first registration request message to the second network comprises:
sending, by the UE, the CS domain registration request message to the second network.

8. The method according to claim 7, wherein:
the second network comprises a Global System for Mobile Communications (GSM) network, a Time Division-Synchronization Code Division Multiple Access (TD-SCDMA) network, or a Wideband Code Division Multiple Access (WCDMA) network.

9. The method according to claim 8, wherein:
when the first communications mode provides the second network mode, the second network mode comprises a GSM network mode, a TD-SCDMA network mode, or a WCDMA network mode.

10. A user equipment UE, comprising:
a determining unit, configured to, when the UE is in a state of accessing a first network in a first network mode of a first communications mode, determine whether the first network supports a first subsystem, wherein the first network mode of the first communications mode is used for supporting access of the UE to the first network, and the first network provides a first service for the UE by using the first subsystem;
a control unit, configured to, when the determining unit determines that the first network does not support the first subsystem and the UE does not access a second network in the first communications mode, enable a second communications mode and access the second network in the second communications mode, wherein in addition to the first network, the second network supports establishment of a first attachment; and
a sending unit, configured to send a first registration request message to the second network, wherein the first registration request message carries first identification information, so that the second network establishes the first attachment according to the first identification information.

11. The UE according to claim 10, wherein:
the control unit is specifically configured to, when the determining unit determines that the first network does not support the first subsystem and the first communications mode provides a second network mode, disable the second network mode of the first communications mode, enable the second communications mode, and access the second network in the second communications mode, wherein the second network mode of the first communications mode is used for supporting access of the UE to the second network.

12. The UE according to claim 10, wherein:
the control unit is specifically configured to, when the first communications mode does not provide a second network mode, enable the second communications mode and access the second network in the second communications mode.

13. The UE according to claim 10, wherein:
the control unit is further configured to enable the first network mode of the first communications mode and access the first network in the first network mode of the first communications mode.

14. The UE according to claim 10, wherein,
the determining unit is further configured to, when the UE is in a state of accessing the first network in the first network mode of the first communications mode and accessing the second network in the second communications mode, determine whether the first network supports the first subsystem;
the sending unit is further configured to send a first deletion request message to the second network when the determining unit determines that the first network supports the first subsystem, wherein the first deletion request message is used by the UE to instruct the second network to delete the first attachment; and
the control unit is further configured to disable the second communications mode after the sending unit sends the first deletion request message to the second network.

15. The UE according to claim 10, further comprising:
a receiving unit, configured to receive a first message sent by the first network, wherein the first message carries identification information about whether the first network supports the first subsystem; and
the determining unit is specifically configured to, according to the identification information carried in the first message received by the receiving unit, determine whether the first network supports the first subsystem.

16. The UE according to claim 10, wherein:
the first network mode comprises a Long Term Evolution LTE network mode, the first network comprises an LTE network, the first subsystem comprises an Internet Protocol multimedia subsystem IMS, and the first service comprises a voice service;
the determining unit is specifically configured to, when the UE is in the LTE network mode of the first communications mode, determine whether the LTE network supports the IMS;
the first attachment comprises a CS domain attachment;
the first registration request message comprises a CS domain registration request message; and
the sending unit is specifically configured to send the CS domain registration request message to the second network.

17. The UE according to claim 16, wherein:
the second network comprises a Global System for Mobile Communications (GSM) network, a Time Division-Synchronization Code Division Multiple Access (TD-SCDMA) network, or a Wideband Code Division Multiple Access (WCDMA) network.

18. The UE according to claim 17, wherein:
when the first communications mode provides the second network mode, the second network mode comprises: a GSM network mode, a TD-SCDMA network mode, or a WCDMA network mode.
